(19) United States
(12) Patent Application Publication
(10) Pub. No.: US 2015/0218448 A1
(43) Pub. Date: Aug. 6, 2015

(54) SOLID HYDROGEL MEDIA AND METHODS OF PREPARATION AND USE THEREFOR

(71) Applicants: Naihong Li, Sunnyvale, CA (US); Quan Gu, Alameda, CA (US); Jen-chieh Wu, Sunnyvale, CA (US)

(72) Inventors: Naihong Li, Sunnyvale, CA (US); Quan Gu, Alameda, CA (US); Jen-chieh Wu, Sunnyvale, CA (US)

(73) Assignee: MOASIS INC, Union City, CA (US)

(21) Appl. No.: 14/428,977

(22) PCT Filed: Sep. 18, 2013
(86) PCT No.: PCT/CA2013/050714

§ 371 Date: Mar. 18, 2015

Related U.S. Application Data
(60) Provisional application No. 61/702,657, filed on Sep. 18, 2012.

(51) Int. Cl. C09K 17/40; C05G 3/04; A01N 25/04

(52) U.S. Cl. CPC C09K 17/40; A01N 25/04; C05G 3/04

(57) ABSTRACT

A solid hydrogel media is provided comprising a suitable hydrophilic hydrogel material, admixed with at least one soil substrate material, and provided in a solid substantially dry form which may be shaped in any convenient or desired shape or configuration. Further, methods of preparation of a solid hydrogel media are also provided. A method of raising an effective groundwater table level for providing water to plants is also provided.

### RELATED APPLICATIONS

This application claims priority to U.S. patent application Ser. No. 61/702,657, filed Sep. 18, 2012, the contents of which are hereby incorporated by reference in their entirety. This application is related to Patent Cooperation Treaty (PCT) Patent Application No. PCT/US2011/059837 filed Nov. 9, 2011, PCT Patent Application No. PCT/CA2013/050656 filed Aug. 23, 2013, and PCT Patent Application No. PCT/CA2013/050673 filed Aug. 30, 2013, which applications are hereby incorporated by reference in their entirety.

### FIELD OF THE INVENTION

The present invention relates generally to hydrogel media and methods of making and using the same. More particularly, the present invention relates to solid hydrogel media products and methods of manufacturing and use in agriculture therefor.

### BACKGROUND TO THE INVENTION

The use of hydrogel materials such as polyacrylamide and polyacrylate hydrogels in agriculture is known for increasing the water absorption capacity of the soil, such as to retain water in the soil for plant use between watering or reduce irrigation water consumption. In such conventional applications, hydrogel materials may typically be separately synthesized and provided in the form of granular particles which may be mixed with existing native soil.

However, such typical in-situ mixed use of particulate hydrogel materials in agricultural soils may in some cases require application of undesirably large quantities of hydrogel to provide adequate coverage of an entire area of agricultural soil, and may typically require additional post-application steps such as to mix the hydrogel particles with the native soil. Further, such typical in-situ mixed use of hydrogel materials may also fail to address potential nutrient or other shortcomings of the native soil, which may necessitate further soil treatment, tilling, or other labor, time or cost intensive steps in order to adequately prepare agricultural soil for planting.

Additionally, other typical in-situ mixed soil uses of particulate hydrogel materials, such as for horticultural or ornamental plant use may require separate hydrogel-soil mixing, planting and/or soil amendment (such as fertilizing or applying other nutrients or soil treatments) steps, necessitating additional time, labor, and/or expense in order to incorporate the separately synthesized particulate hydrogel materials into the native in-situ soil.

### SUMMARY OF THE INVENTION

According to one embodiment of the present invention, a solid hydrogel media is provided comprising a suitable hydrophilic hydrogel material, admixed with at least one soil substrate material, and provided in a solid substantially dry form which may be shaped in any convenient or desired shape, such as a cube, elongate rod or stick, tapered or non-tapered stake, cylinder, curved or rounded or other molded form, or any other desired shape or configuration. In a particular embodiment, a solid hydrogel media comprises a hydrophilic hydrogel material, admixed with at least one soil substrate material, wherein the hydrogel material substantially surrounds and binds the at least one soil substrate material in a solid substantially dry form, and optionally which may also be shaped in any convenient or desired shape or configuration. In another embodiment, the hydrophilic hydrogel material may be polymerized in contact with the at least one soil substrate material. In an optional embodiment, the solid hydrogel media may additionally comprise at least one soil amendment material, such as at least one of: soil nutrient, soil pH control, soil herbicide and/or soil pesticide materials.

According to another embodiment of the present invention, a method of preparation of a solid hydrogel media is provided, wherein the method comprises the steps of:

a) preparing a pre-polymerization mixture of reactants for polymerization of a suitable hydrophilic polymer hydrogel material;

b) adding at least one suitable soil substrate material to the pre-polymerization mixture; and

c) conducting a polymerization reaction to produce the polymer hydrogel material in the presence of the soil substrate material to form a hydrogel and soil substrate solid hydrogel media. In a particular embodiment, the method of preparation may also further comprise the steps of:

d) forming and/or cutting the resulting bulk hydrogel and soil substrate solid hydrogel media into a suitable desired shape or configuration; and

e) drying the hydrogel and soil substrate solid hydrogel media to produce the solid hydrogel media in a suitable desired shape or configuration.

According to yet a further embodiment of the present invention, a method of preparation of a solid hydrogel media product is provided, wherein the method comprises the steps of:

a) providing a suitable hydrophilic hydrogel in particulate form;

b) hydrating the hydrogel by mixing with water to form a flowable substantially liquid hydrated gel;

c) adding at least one suitable soil substrate material to the flowable hydrated gel; and

d) drying the mixture of hydrogel and soil substrate material to form a solid hydrogel media; and

e) forming and/or cutting the resulting bulk solid hydrogel media material into a suitable desired shape or configuration to produce the desired solid hydrogel media product.

According to another embodiment of the present invention, a method of preparation of a solid hydrogel media is provided, wherein the method comprises the steps of:

a) providing a pre-polymerization mixture of reactants for polymerization of a suitable hydrophilic polymer hydrogel material;

b) heating the pre-polymerization mixture to a suitable first polymerization temperature;

c) applying the pre-polymerization mixture onto a layer of at least one suitable soil substrate material; and

d) conducting a polymerization reaction to produce the polymer hydrogel material in the presence of the soil substrate, to form the solid hydrogel media.

In an optional embodiment, the method may additionally comprise the step of heating the layer of at least one suitable soil substrate material to a suitable second polymerization temperature prior to applying the pre-polymerization mixture.

According to yet a further embodiment of the present invention, a method of raising an effective groundwater table level for providing water to plants is provided, comprising:

a) inserting a solid hydrogel media stick into the soil such that a portion of the solid hydrogel media stick is above the groundwater table and a portion of the solid hydrogel media stick is below the groundwater table, where the solid hydrogel media comprises a hydrophilic hydrogel material and at least one soil substrate material admixed with the hydrophilic hydrogel material and where the solid hydrogel media is solid and substantially dry;

b) absorbing groundwater into the hydrogel component of the solid hydrogel media stick in the portion of the solid hydrogel media stick located below the groundwater table; and

c) releasing groundwater and/or soil moisture from the portion of the solid hydrogel media stick located above the groundwater table into the surrounding soil to provide water to at least one plant.

### BRIEF DESCRIPTION OF THE DRAWINGS

FIG. 1 illustrates a cross-sectional view of a solid hydrogel media stick according to an embodiment of the present invention and in use in a sub-surface soil application according to a further embodiment of the present invention.

FIG. 2 illustrates a cross-sectional view of a solid hydrogel media prepared in accordance with an embodiment of the present invention.

FIG. 3 illustrates a cross-sectional view of a further solid hydrogel media prepared in accordance with another embodiment of the present invention.

### DETAILED DESCRIPTION OF SEVERAL EMBODIMENTS OF THE INVENTION

In one embodiment of the present invention, a solid hydrogel media is provided comprising a suitable hydrophilic hydrogel material, admixed with at least one soil substrate material, and provided in a solid substantially dry form which may be shaped in any convenient or desired shape, such as a cube, sphere, elongate rod or stick, tapered or non-tapered stake, cylinder, curved or rounded or other molded form, or any other desired shape. In one such embodiment, the solid hydrogel media may advantageously provide for a solid form of any suitable hydrophilic hydrogel material combined with at least one soil substrate material to desirably facilitate at least one of: handling, packaging, insertion into native soil, and/or targeted insertion or application to a particular desired location such as immediately adjacent to a particular plant, stalk, or root mass, for example. In a particular embodiment, the solid hydrogel media may comprise a hydrophilic hydrogel material, admixed with at least one soil substrate material, wherein the hydrogel material substantially surrounds and binds the at least one soil substrate material into a solid substantially dry form, and which may optionally be shaped in any convenient or desired shape or configuration. In another embodiment, the hydrophilic hydrogel material may be polymerized in contact with the at least one soil substrate material.

In an exemplary embodiment, the solid hydrogel media may be provided in any convenient form or shape, such as a cube or stick, and may comprise at least one suitable hydrophilic hydrogel material, such as but not limited to: polyacrylamide, polyacrylate (such as polyhydroxymethylacrylate), polyvinyl alcohol, and sulphurated polystyrene hydrogel materials, and at least one suitable soil substrate, such as but not limited to: sand, silt, and/or fine gravel. In a particular embodiment, the at least one suitable soil substrate may desirably comprise soil particles with average particle diameters below about 10 mm, and more particularly below about 5 mm, and in another particular embodiment may comprise sand with average particle diameter between about 0.6 mm to 1 mm, for example. In one particular embodiment according to the present invention, a solid hydrogel media may be provided in any desired form or shape and may comprise at least one suitable hydrophilic hydrogel material and at least one suitable soil substrate material in a dry weight ratio of approximately 1:10, for example.

According to one embodiment of the present invention, in any of the exemplary embodiments described below, the at least one suitable hydrophilic hydrogel material may comprise one or more of: polyacrylamide, polyacrylate (such as polyhydroxymethylacrylate), polyvinyl alcohol, and sulphurated polystyrene hydrogel materials. According to another embodiment, in any of the exemplary embodiments described below the at least one suitable hydrophilic hydrogel material may comprise a first polymeric material having polyacrylic acid, and a second polymeric material having a polyglycol other than polyethylene glycol, where the first polymeric material is hydrogen-bonded to the second polymeric material. According to yet another embodiment, in any of the exemplary embodiments described below the at least one suitable hydrophilic hydrogel material may comprise a polyglycol comprising polytetramethylene ether glycol. In another optional embodiment, in any of the exemplary embodiments described below the at least one suitable hydrophilic hydrogel material may comprise at least one polymeric material which is substantially a homopolymer. In another optional embodiment, the at least one suitable hydrophilic hydrogel material may have a bulk porosity of at least 5%.

In another embodiment of the invention, a solid hydrogel media may be provided in any desired form or shape, comprising at least one suitable hydrophilic hydrogel material, at least one suitable soil substrate material, and at least one suitable soil amendment material. In a particular such embodiment, the hydrogel material substantially surrounds and binds the at least one soil substrate material and at least one soil amendment material into a solid substantially dry solid hydrogel media form. In another embodiment, the hydrophilic hydrogel material may be polymerized in contact with the at least one soil substrate material. In one embodiment, the at least one soil amendment material may comprise at least one of: soil nutrient, soil pH control, soil herbicide and/or soil pesticide material, for example. In another embodiment, any suitable soil nutrient material may be included in the solid hydrogel media, such as, but not limited to any suitable: fertilizer, nitrogen/nitrate, potassium, phosphorus, magnesium and/or calcium-containing soil nutrient materials, for example. In yet another embodiment, any suitable soil pH control material may be included in the solid hydrogel media, such as but not limited to: acids, acid salts, acid-forming cations (such as sulfur for example), bases, basic salts, base-producing anions (such as carbonates, lime, but excluding ammonium hydroxide, for example). In a further embodiment, any suitable soil herbicide or pesticide material may be included in the solid hydrogel media, such as may be suitable for countering any weed or pest found in a particular native soil or environment desired for application of the solid hydrogel media, for example.

In a further embodiment of the invention, a solid hydrogel media may be provided in any desired form or shape, comprising at least one suitable hydrophilic hydrogel material, at least one suitable soil substrate material, and at least one suitable plant seed. In one such embodiment, any suitable plant seed, such as but not limited to one or more: crop, ornamental plant, flower, tree, shrub, bush, fruit, or other suitable seed may be included in the solid hydrogel media such as to provide for planting of such seed such as by insertion of the solid hydrogel media (such as in a convenient stick, rod or cube shape, for example) into a suitable native soil material, or other suitable growing environment. In a particular such embodiment, the hydrogel material substantially surrounds and binds the at least one soil substrate material and at least one suitable plant seed into a solid substantially dry solid hydrogel media form. In another embodiment, the hydrophilic hydrogel material may be polymerized in contact with the at least one soil substrate material.

In one embodiment of the present invention, the above-described solid hydrogel media may desirably provide for an easily handled and applied (such as by insertion into native soil) soil improvement product, such as to provide for at least one of: increased soil water absorption capacity, decreased water consumption for given plant water uptake, targeted soil amendment application (such as for one or more of soil nutrients, soil pH control, and/or soil herbicide/pesticide) allowing for application to a specific plant or location and/or preferably reducing quantity of soil amendment required, targeted seed planting (such as by insertion of solid hydrogel media containing at least one seed at desired planting location), reduced leaching of soil amendment materials due to their containment in the solid hydrogel media, and/or improved germination (such as by providing absorbed water, soil substrate, seed and optional soil amendments all within solid hydrogel media for reducing germination stress of seed). In another embodiment of the present invention, the above-described solid hydrogel media may further desirably provide for inclusion of one or more specific soil amendment materials within the solid hydrogel media in order to match a soil deficiency profile for a given native soil, such as may be determined by site-specific soil analysis or testing, for example. In yet another embodiment, the above-described solid hydrogel media may further desirably provide for improving water absorption and/or reducing water runoff or erosion of a layer of soil substrate material, for example.

In another embodiment of the present invention, a method of preparation of a solid hydrogel media is provided, wherein the method comprises the steps of:

a) preparing a pre-polymerization mixture of reactants for polymerization of a suitable hydrophilic polymer hydrogel material;

b) adding at least one suitable soil substrate material to the pre-polymerization mixture;

c) conducting a polymerization reaction to produce the polymer hydrogel material in the presence of the soil substrate material to form a hydrogel and soil substrate solid hydrogel media. In a particular embodiment, the method of preparation may also further comprise the steps of:

d) forming and/or cutting the resulting bulk hydrogel and soil substrate solid hydrogel media into a suitable desired shape or configuration; and

e) drying the hydrogel and soil substrate solid hydrogel media in the suitable desired shape or configuration.

In a further optional embodiment, the above-described methods may further comprise one or more of the following optional steps:

f) adding at least one suitable plant seed to the solid hydrogel media either before or after the above-described optional forming step;

g) adding at least one suitable soil amendment material to the solid hydrogel media;

h) adding at least one suitable soil amendment material to the pre-polymerization mixture; and/or

i) adding at least one suitable soil amendment material to the bulk hydrogel and soil substrate solid hydrogel media.

In one such embodiment for preparing a solid hydrogel media, any suitable plant seed, such as but not limited to one or more: crop, ornamental plant, flower, tree, shrub, bush, fruit, or other suitable seed may be included in the solid hydrogel media such as to provide for planting of such seed such as by insertion of the solid hydrogel media (such as in a convenient stick, rod or cube shape, for example) into a suitable native soil material.

In another such embodiment for preparing a solid hydrogel media, the at least one soil amendment material may comprise at least one of: soil nutrient, soil pH control, soil herbicide and/or soil pesticide material, for example. In one such embodiment, any suitable soil nutrient material may be included in the solid hydrogel media, such as, but not limited to any suitable: fertilizer, nitrogen/nitrate, potassium, phosphorus, magnesium and/or calcium-containing soil nutrient materials, for example. In another such embodiment, any suitable soil pH control material may be included in the solid hydrogel media, such as but not limited to: acids, acid salts, acid-forming cations (such as sulfur for example), bases, basic salts, base-producing anions (such as carbonates, lime, but excluding ammonium hydroxide, for example). In yet another such embodiment, any suitable soil herbicide or pesticide material may be included in the solid hydrogel media, such as may be suitable for countering any weed or pest found in a particular native soil desired for application of the solid hydrogel media, for example.

One particular example of a method of preparation of a solid hydrogel media according to an embodiment of the present invention comprises the following exemplary preparation method:

A first Solution A is prepared by dissolving about 3 kg of acrylic acid in about 4.5 litres of water. A second Solution B is prepared by dissolving about 1620 g of potassium hydroxide into about 4.5 litres of water. Solution A and Solution B are then mixed under mechanical stirring. The resulting mixture is placed into a suitable mixing vessel (such as a suitable 22 litre round bottle flask with mechanical mixer, temperature controller and heating mantel). About 9.0 g of N,N′-methylene bisacrylamide, about 45 g of potassium persulfate, about 30 g of polyacrylic acid and about 60 g of poly(tetramethylene) glycol (PTMG) are then added to the mixture under stir. About 500 g of a suitable soil substrate (such as granular sand with particle diameter between 0.6 mm and 1 mm) is then added to the mixture. A polymerization reaction is then conducted under vigorous stirring at a temperature of about 50-55° C. for about 10 minutes, then rising to about 85-90° C. over about 5-10 minutes, and then maintaining a temperature of about 85-90° C. for about 3 hours. The resulting bulk hydrogel and soil substrate product is then removed from the reactor and cut or formed by any suitable means into a desired suitable shape or configuration (such as approximately 2.5 cm square sticks about 30 cm in length) and dried at about 70° C. for a suitable period such as overnight (e.g. 8-16 hours) to produce the desired solid hydrogel media in the desired exemplary shape of a stick.

In a further embodiment of the present invention, a method of preparation of a solid hydrogel media product is provided, wherein the method comprises the steps of:

a) providing a suitable hydrophilic hydrogel in particulate form;

b) hydrating the hydrogel by mixing with water to form a flowable substantially liquid hydrated gel;

c) adding at least one suitable soil substrate material to the flowable hydrated gel; and

d) drying the mixture of hydrogel and soil substrate material to form a solid hydrogel media; and

e) forming and/or cutting the resulting bulk solid hydrogel media material into a suitable desired shape or configuration to produce the desired solid hydrogel media product.

In a further optional such embodiment, the above-described methods may further comprise one or more of the following optional steps:

f) adding at least one suitable plant seed to the solid hydrogel media product;

g) adding at least one suitable soil amendment material to the solid hydrogel media product; and/or

h) adding at least one suitable soil amendment material to the flowable hydrated gel.

In one such embodiment for preparing a solid hydrogel media product, any suitable plant seed, such as but not limited to one or more: crop, ornamental plant, flower, tree, shrub, bush, fruit, or other suitable seed may be included in the solid hydrogel media product such as to provide for planting of such seed such as by insertion of the solid hydrogel media product (such as in a convenient stick, rod or cube shape, for example) into a suitable native soil material.

In another such embodiment for preparing a solid hydrogel media product, the at least one soil amendment material may comprise at least one of: soil nutrient, soil pH control, soil herbicide and/or soil pesticide material, for example. In one such embodiment, any suitable soil nutrient material may be included in the solid hydrogel media product, such as, but not limited to any suitable: fertilizer, nitrogen/nitrate, potassium, phosphorus, magnesium and/or calcium-containing soil nutrient materials, for example. In another such embodiment, any suitable soil pH control material may be included in the solid hydrogel media, such as but not limited to: acids, acid salts, acid-forming cations (such as sulfur for example), bases, basic salts, base-producing anions (such as carbonates, lime, but excluding ammonium hydroxide, for example). In yet another such embodiment, any suitable soil herbicide or pesticide material may be included in the solid hydrogel media product, such as may be suitable for countering any weed or pest found in a particular native soil desired for application of the solid hydrogel media, for example.

One particular example of a method of preparation of a solid hydrogel media product according to an embodiment of the present invention comprises the following exemplary preparation method:

About 100 g of a suitable hydrophilic hydrogel (such as in commonly available particular form) may be mixed with about 15 litres of water under stirring until all of the water is absorged into the gel and a flowable substantially liquid hydrated gel results. The about 1000 g of a suitable soil substrate material (such as granular sand with particle diameters between about 0.6 and 2 mm for example) may be added to the flowable liquid gel. The resulting mixture may then be dried to form a bulk solid hydrogel media. The bulk dried media may then be cut or otherwise formed by any suitable means into a desired suitable shape or configuration (such as approximately 1-2 cm cubes for example). At least one suitable plant seed may then be inserted into or otherwise suitably attached to the cut or formed solid hydrogel media to produce the desired solid hydrogel media product, such as may be suitable for planting in soil, and watering to result in hydration of the hydrogel media and germination of the plant seed.

In an optional example of the above exemplary method, the solid hydrogel media product may also comprise at least one soil amendment material, such as a soil nutrient, pH control material and/or herbicide/pesticide material such as may be desirable for addressing a deficiency or shortcoming of a particular native soil into which the solid hydrogel media product is desired to be planted. In one such example, the at least one soil amendment material may be added either to the hydrated gel before drying, or to the dried solid hydrogel media after drying. In one embodiment of the exemplary method, the solid hydrogel media product may comprise the at least one soil amendment material to facilitate reduced water and nutrient stress during germination of the plant seed after planting and watering of the solid hydrogel media product in a native soil, such as to desirably result in at least one of: greater plant root mass, shorter root length, and optimal germination, for example.

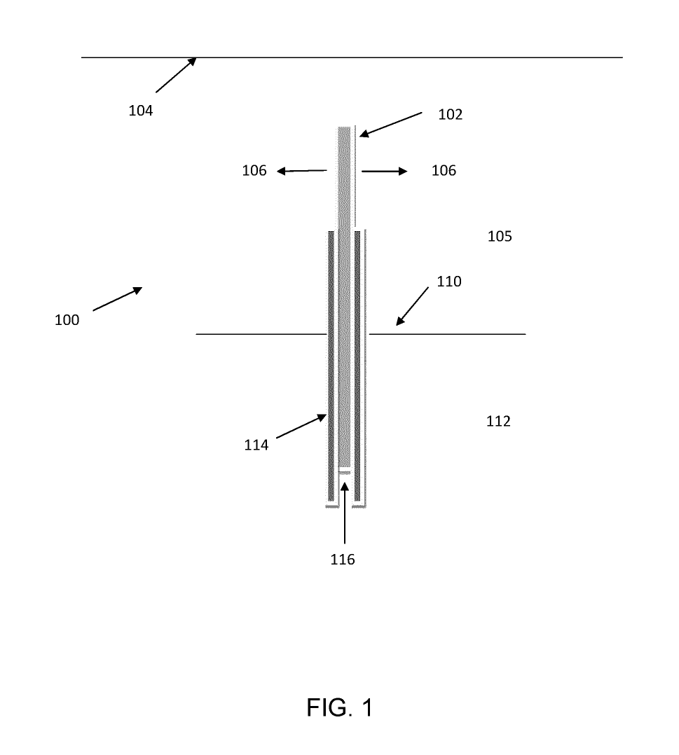

With reference to FIG. 1, a cross-sectional view of a solid hydrogel media stick 102 is shown (in an exemplary elongated stick form) according to an embodiment of the present invention. The exemplary solid hydrogel media stick 102 shown in FIG. 1 is also shown in use in a sub-surface soil application 100 according to a further embodiment of the present invention. Similar to as described in the embodiments above, the solid hydrogel media stick 102 shown in FIG. 1 may comprise at least one suitable hydrophilic hydrogel material, and at least one suitable soil substrate material, and is preferably provided in a solid substantially dry form which may be shaped in any convenient or desired shape or configuration, such as the elongated stick 102 shown in FIG. 1. In a particular such embodiment, the hydrogel material substantially surrounds and binds the at least one soil substrate material into a solid substantially dry solid hydrogel media form. In another embodiment, the hydrophilic hydrogel material may be polymerized in contact with the at least one soil substrate material. Also as described in the embodiments above, the solid hydrogel media stick 102 may further also comprise at least one plant seed, and/or at least one soil amendment material, such as may be advantageous to improve germination and/or growing conditions for at least one plant, for example.

FIG. 1 also shows a method of application of a solid hydrogel media stick 102 in a sub-surface soil environment 100 to raise the effective groundwater table level, where the solid hydrogel media stick 102 is inserted in or buried below the soil surface 104. In such an application, the groundwater table 110 may be located substantially below the soil surface 104, such that at least a portion of the sub-surface soil lies above the groundwater table 110, and is therefore unsaturated, while the lower region of soil 112 located below the groundwater table 110 is typically saturated with groundwater. In an exemplary method of use illustrated in FIG. 1, the solid hydrogel media stick 102 may be inserted below the surface of the soil 104 such that at least a portion of the stick 102 extends below the groundwater table 110 into the saturated soil region 112, while at least a portion of the stick 102 remains above the groundwater table 110 in the unsaturated soil region 105, such as where plants are typically planted and a majority of their growth takes place.

In the illustrated application, the solid hydrogel media stick 102 may desirably absorb water from the saturated soil 112 below the groundwater table 110 such as by hydration of the hydrogel component of the stick, and release water and/or soil moisture 106 to the unsaturated soil 105 above the groundwater table 110, such as where it may be of greatest benefit to plants, and particularly to seeds and/or young plants which may not have sufficient root depth to reach moisture located at greater depths of the soil. Application of the above-described method for raising the effective level of the groundwater table 110 may desirably provide for the water needs of a plant such as a crop plant, while reducing water consumption relative to surface watering. In particular areas where groundwater supplies are stressed from overuse, such a method may desirably provide for efficient use of groundwater resources for sustaining plant growth, without the requirement for surface extraction of groundwater such as by installing a well, for example.

In one embodiment, a solid hydrogel media product, such as one or more solid hydrogel media sticks 102, when inserted or buried in the ground and extending down to the level of an underground groundwater table 110, may desirably transport subsurface water 106 from the groundwater table 110 up to an unsaturated soil region 105 and release such subsurface water or soil moisture 106 for access by plant roots in the unsaturated region 105, for example. In another embodiment, a solid hydrogel media product, such as one of more solid hydrogel media sticks 102, can absorb water from the soil surface 104 or near surface that may otherwise be lost due to runoff or erosion, and may desirably allow for recycle or reuse of such absorbed water by plants such as by plant roots located under the surface of the soil, for example.

In an optional embodiment of the above-described method, one or more individual solid hydrogel media sticks may be used in order to reach below the groundwater table 110, such as when the groundwater table 110 is significantly below the soil surface 104. In one such an optional embodiment, one or more solid hydrogel media sticks 102 may be supported inside an optional support tube 114 or other suitable support means such that the one or more solid hydrogel media sticks 102 may be easily inserted into the soil to at least the depth of the groundwater table 110, for example. In one embodiment, one or more solid hydrogel media such as sticks 102 may then absorb a portion of subsurface groundwater 116 and move up the stick(s) 102 such as to be released as water or soil moisture 106 in an unsaturated soil zone 105 above the groundwater table 110, such as for availability and use by plants with roots in the unsaturated zone 105, for example.

In another embodiment of the invention, a method for using a solid hydrogel media product, such as a solid hydrogel media stick 102, may comprise inserting the stick 102 into the soil next to or under an existing plant, such as a shrub, tree, bush, crop plant or ornamental plant, such as to provide at least one of water and/or soil amendment materials such as soil nutrients for plant use. In a particular embodiment, such a method may be particularly suited for providing water and/or nutrients to a variety of trees, such as but not limited to pine, spruce, dogwood, arborvitae and juniper trees, for example. In another embodiment, the hydrogel media product, such as hydrogel media stick 102 may be inserted into the soil next to or under an existing plant to at least the depth of the groundwater table 110 beneath the plant, and may desirably transport subsurface water 116 from at or below the groundwater table 110 upwards for use by the plant, such as to be released as water or soil moisture 106 for use by the roots of the plant located in an unsaturated soil region 105 located below the soil surface 104 but above the groundwater table 110, for example. In a further embodiment, a solid hydrogel media product, such as a hydrogel media stick 102, or an in-situ solid hydrogel media layer comprising polymerized hydrogel material surrounding and binding an in-situ surface soil substrate material layer, may be utilized at the surface of the soil 104, and may extend down below the soil surface 104, and may desirably absorb surface water which may otherwise be lost to runoff or erosion, and allow for recycle and/or reuse of such water by plants, such as by providing such water to plant roots located below the soil surface 104. In yet a further embodiment, the use of a solid hydrogel media according to an embodiment of the invention shown above may desirably bind the soil substrate material with the surrounding hydrogel material, and may thereby substantially immobilize the surface soil substrate material thereby desirably reducing potential for erosion of the soil substrate material by water and/or wind, for example.

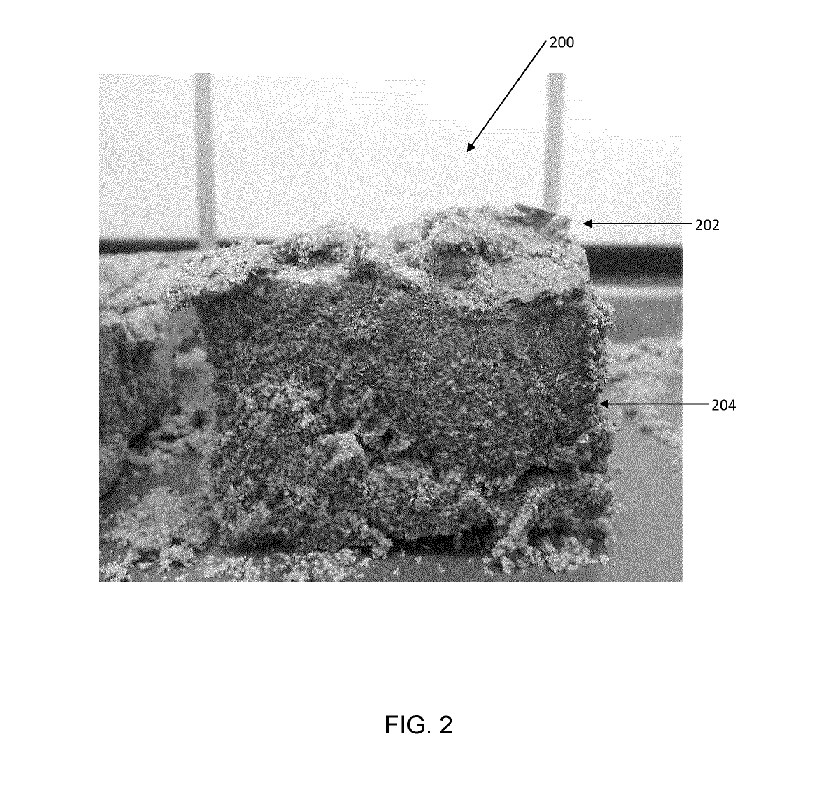

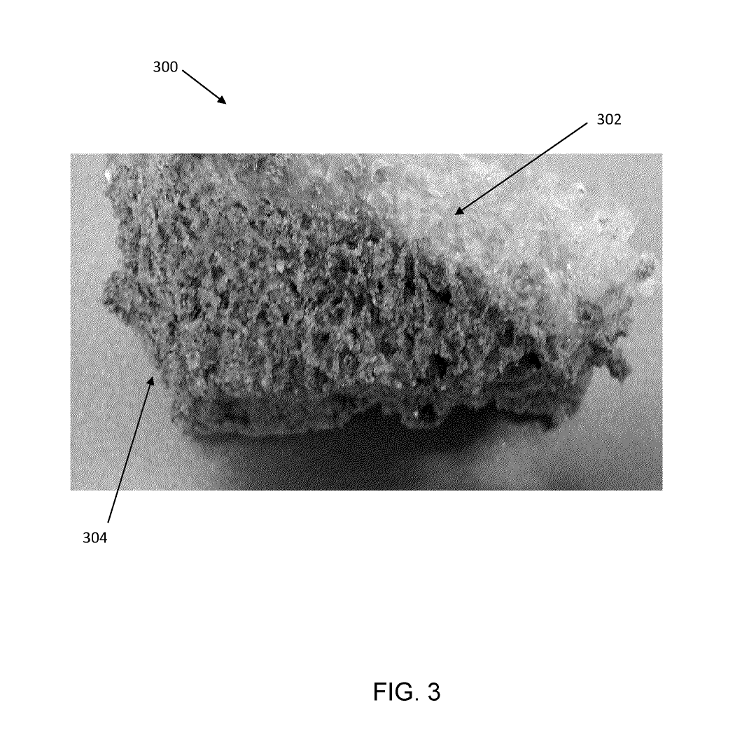

Referring now to FIGS. 2 and 3, cross-sectional views of two exemplary solid hydrogel media 200 and 300 prepared in accordance with embodiments of the present invention are shown.

According to one embodiment of the present invention, a method of preparation of a solid hydrogel media is provided, where the method comprises the steps of:

a) providing a pre-polymerization mixture of reactants for polymerization of a suitable hydrophilic polymer hydrogel material;

b) heating the pre-polymerization mixture to a suitable first polymerization temperature;

c) applying the pre-polymerization mixture onto a layer of at least one suitable soil substrate material; and

d) conducting a polymerization reaction to produce the polymer hydrogel material in the presence of the soil substrate to produce the solid hydrogel media.

In an optional embodiment, the method may additionally comprise the step of heating the layer of at least one suitable soil substrate material to a suitable second polymerization temperature prior to applying the pre-polymerization mixture.

According to one embodiment of the present invention, the solid hydrogel media 200 illustrated in FIG. 2 may be prepared by the following exemplary method of preparation:

A pre-polymerization reaction solution for a hydrophilic hydrogel is prepared by combining about 1333 g of acrylic acid, 720 g of potassium hydroxide, 4 g of N,N′-bisacrylamide, 13.33 g of poly(acrylic acid), 26.67 g of poly(tetrahydrofuran), 20 g of potassium persulfate, and 2333 mL of water in a suitable mixing vessel (such as a 22 L glass reactor vessel) and mixing under stir (such as by a mechanical stirrer) at about 250 rpm. The temperature of the pre-polymerization solution is maintained at 60° C. during the combination and mixing of the reactants. A suitable soil substrate material is provided as a soil substrate layer, and in one embodiment, such suitable soil substrate material may comprise an in-situ layer of suitable sandy soil, such as an in-situ layer of sandy loam soil, for example. The temperature of the soil substrate layer is approximately 35° C. The pre-polymerization solution is then applied to the soil substrate material, such as by pouring the heated (approximately 60° C.) pre-polymerization solution onto the top surface 202 of the soil substrate material layer. A polymerization reaction then occurs in-situ on the surface 202 and within the underlying soil matrix 204 of the soil substrate material layer in about 15 minutes, to produce the solid hydrogel media 200 comprising the polymerized hydrophilic hydrogel mixed with and surrounding the soil substrate material.

In one embodiment, where the soil substrate material comprises an in-situ upper layer of a soil unit, the resulting solid hydrogel media 200 may subsequently be left in-situ as the surface layer of the in-situ soil, and may desirably immobilize the soil substrate material at the surface 202 and the soil substrate matrix 204 immediately underlying the surface 202, such as to desirably reduce erosion of the in-situ soil by water and/or wind. In another embodiment, the soil hydrogel media 200 produced by the above-described exemplary method may subsequently be cut and/or otherwise shaped into any suitable form or configuration for use as a solid hydrogel product, for example.

Similar to as described above, in a particular embodiment, the solid hydrogel media 200 shown in FIG. 2 may comprise at least one suitable hydrophilic hydrogel material, and at least one suitable soil substrate material, wherein the hydrogel material substantially surrounds and binds the at least one soil substrate material into a solid and substantially dry solid hydrogel media 200. In an optional embodiment, the solid hydrogel media 200 may be provided in a solid substantially dry form which may be left as an in-situ upper layer of an in-situ soil unit, or may further optionally be shaped in any convenient or desired shape or configuration, such as an elongated hydrogel stick, substantially cubic hydrogel media unit, or any other desired shape, for example. Also as described in the embodiments above, the solid hydrogel media 200 may further also comprise at least one plant seed, and/or at least one soil amendment material, such as may be advantageous to improve germination and/or growing conditions for at least one plant, for example.

According to another embodiment of the present invention, the solid hydrogel media 300 illustrated in FIG. 3 may be prepared by the following exemplary method of preparation:

A pre-polymerization reaction solution for a hydrophilic hydrogel is prepared by combining 1333 g of acrylic acid, 720 g of potassium hydroxide, 4 g of N,N′-bisacrylamide, 13.33 g of poly(acrylic acid), 26.67 g of poly(tetrahydrofuran), 20 g of potassium persulfate, and 2333 mL of water in a suitable mixing vessel (such as a 22 L glass reactor vessel) and mixing under stir (such as by a mechanical stirrer) at about 250 rpm. The temperature of the pre-polymerization solution is maintained at 60° C. during the combination and mixing of the reactants. A suitable soil substrate material is provided as a soil substrate layer, and in one embodiment, such suitable soil substrate material may comprise an in-situ layer of suitable sandy soil, such as an in-situ layer of sandy loam soil, for example. The temperature of the soil substrate layer is then heated to approximately 90° C. The pre-polymerization solution is then applied to the soil substrate material, such as by pouring the (approximately 60° C.) pre-polymerization solution onto the top surface 302 of the heated (approximately 90° C.) soil substrate material layer. A polymerization reaction then occurs substantially immediately in-situ on the surface 302 and within the underlying soil matrix 304 of the soil substrate material layer, to produce the solid hydrogel media 300 comprising the polymerized hydrophilic hydrogel mixed with and surrounding the soil substrate material.

In one embodiment, where the soil substrate material comprises an in-situ upper layer of a soil unit, the resulting solid hydrogel media 300 may subsequently be left in-situ as the surface layer of the in-situ soil, and may desirably immobilize the soil substrate material at the surface 302 and the soil substrate matrix 304 immediately underlying the surface 302, such as to desirably reduce erosion of the in-situ soil by water and/or wind. In another embodiment, the soil hydrogel media 300 produced by the above-described exemplary method may subsequently be cut and/or otherwise shaped into any suitable form or configuration for use as a solid hydrogel product, for example.

Similar to as described in embodiments above, in a particular embodiment, the solid hydrogel media 300 shown in FIG. 3 may comprise at least one suitable hydrophilic hydrogel material, and at least one suitable soil substrate material, wherein the hydrogel material substantially surrounds and binds the at least one soil substrate material into a solid and substantially dry solid hydrogel media 300. In an optional embodiment, the solid hydrogel media 300 may be provided in a solid substantially dry form which may be left as an in-situ upper layer of an in-situ soil unit, or may further optionally be shaped in any convenient or desired shape or configuration, such as an elongated hydrogel stick, substantially cubic hydrogel media unit, or any other desired shape, for example. Also as described in the embodiments above, the solid hydrogel media 300 may further also comprise at least one plant seed, and/or at least one soil amendment material, such as may be advantageous to improve germination and/or growing conditions for at least one plant, for example.

The above description of exemplary embodiments of the present invention, including what is described in the Abstract, is not intended to be exhaustive or to limit the embodiments of the invention to the precise forms disclosed above. Although specific embodiments and examples are described herein for illustrative purposes and to allow others skilled in the art to comprehend their teachings, various equivalent modifications may be made without departing from the scope of the disclosure, as will be recognized by those skilled in the relevant art.

1. A solid hydrogel media, comprising:
a hydrophilic hydrogel material and
at least one soil substrate material admixed with said hydrophilic hydrogel material,
wherein said solid hydrogel media is solid and substantially dry.

2. The solid hydrogel media according to claim 1, wherein said solid hydrogel media is further capable of being at least one of shaped, molded, and formed into at least one configuration of a cube, a sphere, an elongated rod, a stick, and a stake.

3. The solid hydrogel media according to claim 1, wherein said hydrophilic hydrogel material substantially surrounds and binds said at least one soil substrate material.

4. The solid hydrogel media according to claim 3, wherein said hydrophilic hydrogel material is polymerized in contact with said at least one soil substrate material.

5. The solid hydrogel media according to claim 1, further comprising at least one soil amendment material.

6. The solid hydrogel media according to claim 5, wherein said at least one soil amendment material comprises at least one of a soil nutrient, a soil pH controller, a soil herbicide, and a soil pesticide material. U

7. The solid hydrogel media according to claim 1, wherein said at least one hydrophilic hydrogel comprises at least one of a polyacrylamide, a polyacrylate, a polyhydroxymethylacrylate, a polyvinyl alcohol, and a sulphurated polystyrene hydrogel material.

8. The solid hydrogel media according to claim 1, wherein said at least one soil substrate material comprises at least one of sand, silt, and fine gravel.

9. The solid hydrogel media according to claim 1, wherein said at least one soil substrate material comprises soil particles having an average particle diameter range of at least one of less than approximately 10 mm, less than approximately 5 mm, and between approximately 0.6 mm to approximately 1 mm.

10. The solid hydrogel media according to claim 1, further comprising at least one plant seed.

11. A method of preparing a solid hydrogel comprising:
preparing a pre-polymerization mixture of reactants for polymerization of a hydrophilic polymer hydrogel material;
adding at least one soil substrate material to the pre-polymerization mixture; and
polymerizing the hydrophilic polymer hydrogel material in the presence of the at least one soil substrate material,
thereby forming the solid hydrogel media.

12. The method of peparing a solid hydrogel media according to claim 11, further comprising:
configuring the solid hydrogel media into a desired shape; and
drying the solid hydrogel media in said desired shape.

13. A method of preparing a solid hydrogel media, comprising:
providing a pre-polymerization mixture of reactants for polymerization of a hydrophilic polymer hydrogel material;
heating the pre-polymerization mixture to a first polymerization temperature;
applying the pre-polymerization mixture onto a layer of at least one soil substrate material; and
polymerizing the hydrophilic polymer hydrogel material in the presence of the soil substrate material,
thereby forming the solid hydrogel media.

14. The method of claim 13, further comprising heating said layer of at least one soil substrate material to a second polymerization temperature prior to applying the pre-polymerization mixture.

15-20. (canceled)

21. A method of preparing a solid hydrogel media product comprising:
providing a hydrophilic hydrogel in particulate form;
hydrating the hydrophilic hydrogel by mixing with water to form a flowable substantially liquid hydrated gel;
adding at least one soil substrate material to the flowable hydrated gel to form a mixture of hydrated hydrogel and soil substrate material;
drying the mixture of hydrogel and soil substrate material to form a solid hydrogel media; and
configuring the solid hydrogel media into a desired shape, thereby forming the solid hydrogel media product.

22. The method according to claim 21, further comprising adding at least one plant seed to the solid hydrogel media product.

23. The method according to claim 21, further comprising at least one of:
adding at least one soil amendment material to the solid hydrogel media product; and
adding at least one suitable soil amendment material to the flowable hydrated gel.

24. The method according to claim 23, wherein the at least one soil amendment material comprises at least one of a soil nutrient, a soil pH controller, a soil herbicide, and a soil pesticide material.

25-27. (canceled)

28. The method of claim 14, further comprising at least one of:
adding at least one plant seed to the solid hydrogel media;
adding at least one soil amendment material to the solid hydrogel media;
adding at least one soil amendment material to the pre-polymerization mixture; and
adding at least one soil amendment material to the soil substrate material,
wherein said layer of at least one soil substrate material comprises an in-situ upper layer of a soil unit,
wherein the at least one soil amendment material comprises at least one of a soil nutrient, a soil pH controller, a soil herbicide, and a soil pesticide material,
wherein said at least one soil substrate material comprises soil particles having an average particle diameter range of at least one of less than approximately 10 mm, less than approximately 5 mm, and between approximately 0.6 mm and approximately 1 mm, and
wherein said at least one hydrophilic hydrogel comprises at least one of polyacrylamide, polyacrylate, polyhydroxymethylacrylate, polyvinyl alcohol, and a sulphurated polystyrene hydrogel material.

29. The method according to claim 24,
wherein said at least one soil substrate material comprises soil particles having an average particle diameter range of at least one of less than approximately 10 mm, less than approximately 5 mm, and between approximately 0.6 mm and approximately 1 mm, and
wherein said at least one hydrophilic hydrogel comprises at least one of polyacrylamide, polyacrylate, polyhydroxymethylacrylate, polyvinyl alcohol, and a sulphurated polystyrene hydrogel material.
